(19) United States
(12) Patent Application Publication
(10) Pub. No.: US 2025/0390968 A1
(43) Pub. Date: Dec. 25, 2025

(54) METHODS, SYSTEMS, AND DEVICES FOR FACILITATING INTERACTIVE AND GUIDED EXPERIENCING OF VIRTUAL REAL ESTATE PROPERTIES

(71) Applicant: SY Interiors Pvt. Ltd., New Delhi (IN)

(72) Inventors: Sunder Jagannathan, Coimbatore (IN); Vivek Agarwal, Faridabad (IN); Hitesh Singla, Gurgaon (IN); Piyush Bothra, Gurgaon (IN)

(73) Assignee: SY Interiors Pvt. Ltd., New Delhi (IN)

(21) Appl. No.: 18/747,477

(22) Filed: Jun. 19, 2024

(51) Int. Cl. G06Q 50/16; G06F 9/451; G06Q 30/0601

(52) U.S. Cl. CPC G06Q 50/16; G06F 9/451; G06Q 30/0643

(57) ABSTRACT

A method of facilitating interactive and guided experiencing of virtual real estate properties. Further, the method comprises receiving, using a communication device, a request from a user device associated with a user, generating, using a processing device, an interactive representation associated with a real estate property based on the request, transmitting, using the communication device, the interactive representation to the user device, receiving, using the communication device, an input associated with the user from the user device, obtaining, using the processing device, an output corresponding to an agent avatar based on the input, generating, using the processing device, an exploring parameter for exploring the interactive representation by the user avatar with the agent avatar based on the input and the output, transmitting, using the communication device, the exploring parameter and the output to the user device, and storing, using a storage device, the interactive representation.

### FIELD OF THE INVENTION

Generally, the present disclosure relates to the field of data processing. More specifically, the present disclosure relates to methods, systems, and devices for facilitating interactive and guided experiencing of virtual real estate properties.

### BACKGROUND OF THE INVENTION

The field of data processing is technologically important to several industries, business organizations, and/or individuals. In particular, the use of data processing is prevalent for methods, systems, and devices for facilitating interactive and guided experiencing of virtual real estate properties.

Existing techniques for facilitating interactive and guided experiencing of virtual real estate properties are deficient with regard to several aspects. For instance, current technologies do not provide a user with the experience of virtually interacting with an avatar for viewing virtual real estate properties. As a result, different technologies are needed that provide the user with the experience of virtually interacting with the avatar for viewing the real estate properties. Furthermore, the current technologies do not provide the rendering of the exploring of the virtual real estate properties by the user on the devices based on the specifications of the devices. As a result, different technologies are needed that render the exploring of the virtual real estate properties by the user on the devices based on the specifications (characteristics) of the devices.

Therefore, there is a need for improved methods, systems, and devices for facilitating interactive and guided experiencing of virtual real estate properties that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating interactive and guided experiencing of virtual real estate properties, in accordance with some embodiments. Accordingly, the method may include a step of receiving, using a communication device, at least one request from at least one user device associated with at least one user. Further, the method may include a step of generating, using a processing device, at least one interactive representation associated with at least one real estate property based on the at least one request. Further, the method may include a step of transmitting, using the communication device, the at least one interactive representation to the at least one user device. Further, the method may include a step of receiving, using the communication device, at least one input associated with the at least one user from the at least one user device. Further, the method may include a step of obtaining, using the processing device, at least one output corresponding to the at least one agent avatar based on the at least one input. Further, the method may include a step of generating, using the processing device, at least one exploring parameter for exploring the at least one interactive representation by the at least one user avatar with the at least one agent avatar based on the at least one input and the at least one output. Further, the method may include a step of transmitting, using the communication device, the at least one exploring parameter and the at least one output to the at least one user device. Further, the method may include a step of storing, using a storage device, the at least one interactive representation.

Further disclosed herein is a system for facilitating interactive and guided experiencing of virtual real estate properties, in accordance with some embodiments. Accordingly, the system may include a communication device configured for receiving at least one request from at least one user device associated with at least one user. Further, the communication device may be configured for transmitting at least one interactive representation to the at least one user device. Further, the communication device may be configured for receiving at least one input associated with the at least one user from the at least one user device. Further, the communication device may be configured for transmitting at least one exploring parameter and at least one output to the at least one user device. Further, the system may include a processing device configured for generating the at least one interactive representation associated with at least one real estate property based on the at least one request. Further, the processing device may be configured for obtaining the at least one output corresponding to the at least one agent avatar based on the at least one input. Further, the processing device may be configured for generating the at least one exploring parameter for exploring the at least one interactive representation by the at least one user avatar with the at least one agent avatar based on the at least one input and the at least one output. Further, the system may include a storage device configured for storing the at least one interactive representation.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a flowchart of a method 200 for facilitating interactive and guided experiencing of virtual real estate properties, in accordance with some embodiments.

FIG. 3 is a flowchart of a method 300 for facilitating interactive and guided experiencing of virtual real estate properties, in accordance with some embodiments.

FIG. 4 is a flowchart of a method 400 for facilitating interactive and guided experiencing of virtual real estate properties, in accordance with some embodiments.

FIG. 5 is a flowchart of a method 500 for facilitating interactive and guided experiencing of virtual real estate properties, in accordance with some embodiments.

FIG. 6 is a block diagram of a system 600 for facilitating interactive and guided experiencing of virtual real estate properties, in accordance with some embodiments.

FIG. 7 is a block diagram of the system 600 for facilitating interactive and guided experiencing of virtual real estate properties, in accordance with some embodiments.

FIG. 8 is a block diagram of the system 600 for facilitating interactive and guided experiencing of virtual real estate properties, in accordance with some embodiments.

FIG. 9 is a block diagram of the system 600 for facilitating interactive and guided experiencing of virtual real estate properties, in accordance with some embodiments.

FIG. 10 is a block diagram of the system 600 for facilitating interactive and guided experiencing of virtual real estate properties, in accordance with some embodiments.

FIG. 11 is a schematic of an interactive representation 1100 of a geographical area, in accordance with some embodiments.

FIG. 12 is a schematic of an interactive representation 1200 of a location associated with the at least one real estate property, in accordance with some embodiments.

FIG. 13 is a schematic of an interactive representation 1300 of a location associated with the at least one real estate property, in, in accordance with some embodiments.

FIG. 14 is a schematic of an interactive representation 1400 of a location associated with the at least one real estate property, in, in accordance with some embodiments.

FIG. 15 is a schematic of an interactive representation 1500 of a location associated with the at least one real estate property, in, in accordance with some embodiments.

FIG. 16 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, and devices for facilitating interactive and guided experiencing of virtual real estate properties, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor. Examples of the one or more client devices and/or the server computer may include, a desktop computer, a laptop computer, a tablet computer, a personal digital assistant, a portable electronic device, a wearable computer, a smartphone, an Internet of Things (IOT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer and/or the computing device may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer and/or the computing device may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer and/or the computing device may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods, systems, and devices for facilitating interactive and guided experiencing of virtual real estate properties.

Further, the present disclosure describes an interactive representation of a real estate property comprising a user's avatar and a sales agent's avatar. Further, the user's avatar enter a virtual sales location of the real estate property. The virtual sales location has the sales agent's avatar. The user's avatar may communicate with the sales agent's avatar in the virtual sales location. The sales agent's avatar may navigate the user's avatar through the interactive representation of the real estate property and the user views the interactive representation of the real estate property from the perspective of the user's avatar. Further, in an embodiment, the sales agent's avatar may be of a real person such as a sales agent. Further, in an embodiment, the sales agent's avatars may be AI-generated that may be trained to interact with the user's avatar based on verbal cues and other nonverbal cues from the user's avatar.

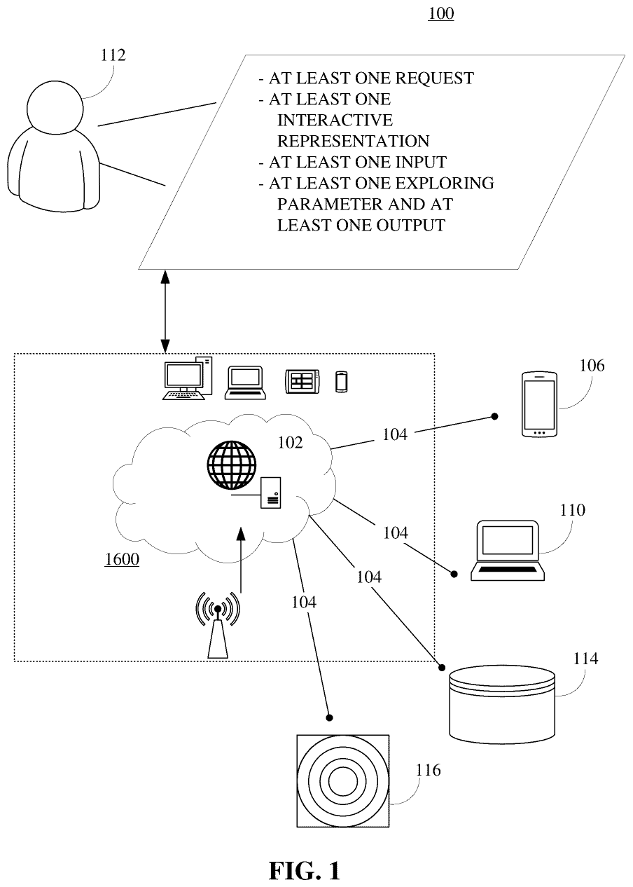

Further, the present disclosure describes modifying an interactive representation of a real estate property for facilitating interactive and guided experiencing of virtual real estate properties. Further, the interactive representation of the real estate property is presented from the perspective of the user's avatar to the user. The user's avatar may navigate to different locations of the interactive representation of the real estate property and change their perspective for viewing the interactive representation of the real estate property based on inputs from the user. Further, the user may communicate with the other avatars through the user's avatar. Further, the user's avatar may navigate with or without the other avatars (sales agent's avatar) to different locations in the interactive representation of the real estate property and control the perspective of the user's avatar based on the communications between the user's avatar and the other avatars. Further, the different locations of the interactive representation of the real estate property are presented to the user from the perspective of the user's avatar. Further, the other avatars may be AI-generated and perform a role in the virtual real estate property. Moreover, the other avatars interact with the user avatar based on their roles. FIG. 1 is an illustration of an online platform 100 consistent with various embodiments of the present disclosure. By way of non-limiting example, the online platform 100 to facilitate interactive and guided experiencing of virtual real estate properties may be hosted on a centralized server 102, such as, for example, a cloud computing service.

The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, real estate customers, real estate agents, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1600.

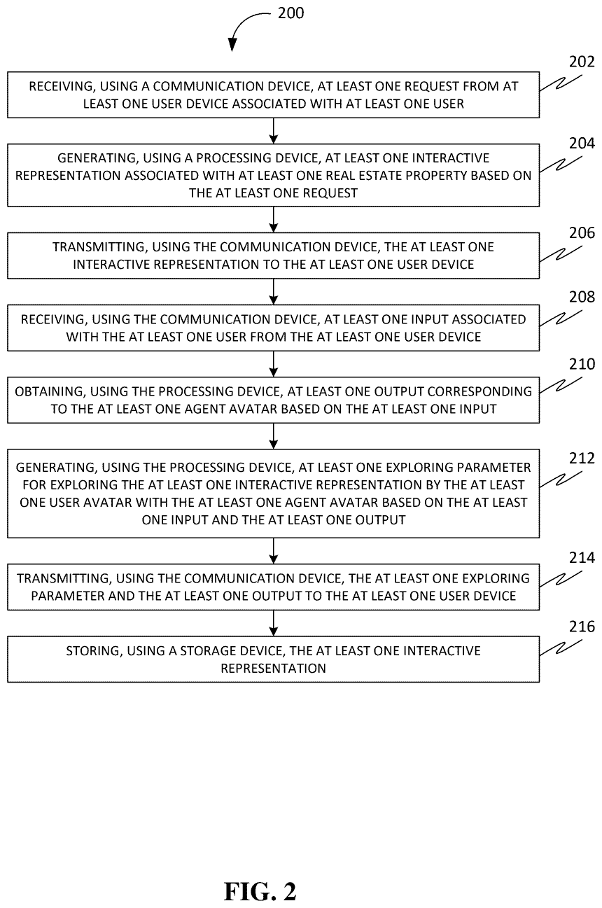

FIG. 2 is a flowchart of a method 200 for facilitating interactive and guided experiencing of virtual real estate properties, in accordance with some embodiments.

Further, at 202, the method 200 may include receiving, using a communication device (such as a communication device 602), at least one request from at least one user device (such as at least one user device 702) associated with at least one user. Further, the at least one user device may include, but may not be limited to, a computing device, a smartphone, a virtual reality headset, a mixed reality headset, a laptop, a desktop, a tablet, etc. Further, at least one of the virtual reality headset and the mixed reality headset may be worn by the at least one user.

Further, at 204, the method 200 may include generating, using a processing device (such as a processing device 604), at least one interactive representation associated with at least one real estate property based on the at least one request. Further, the at least one interactive representation may include at least one agent avatar and at least one user avatar associated with the at least one user. Further, the at least one interactive representation may be a three-dimensional interactive representation, a two-dimensional interactive representation, etc. Further, the at least one request may include at least one indication of the at least one real estate property. Further, the at least one user device may include at least one sensor. Further, the at least one sensor may be configured for generating the at least one sensor data based on detecting at least one of an utterance, a movement, an expression made by the at least one user. Further, the at least one user device may include a processing device communicatively coupled with the at least one sensor. Further, the processing device may be configured for analyzing the at least one sensor data using at least one machine learning model. Further, the at least one machine learning model may include a convolution neural network and a natural language processing model. Further, the at least one machine learning model may be trained for obtaining at least one indication of the at least one real estate property from at least one of the utterance, the movement, the expression of the at least one user. Further, the at least one machine learning model may be trained on a dataset using at least one algorithm. Further, the at least one algorithm may include Multiclass Support Vector Machines (SVM), Convolutional Neural Networks (CNN), Recurrent Neural

Networks (RNN), Convolutional Long Short-Term Memory (ConvLSTM), etc. Further, the at least one machine learning model may be a feature extraction model which identifies identifiers of real estate properties. Further, the at least one user avatar may include digital representations and/or virtual representations of the at least one user. Further, the at least one agent avatar may include digital representations and/or virtual representations of at least one agent. Further, the at least one agent may include a sales agent of the at least one real estate property.

Further, at 206, the method 200 may include transmitting, using the communication device, the at least one interactive representation to the at least one user device. Further, the at least one user device may be configured for presenting the at least one interactive representation to the at least one user.

Further, at 208, the method 200 may include receiving, using the communication device, at least one input associated with the at least one user from the at least one user device. Further, the at least one input may include at least one of an utterance, a movement, an expression of the at least one user. Further, the at least one user may experience the at least one interactive real estate presentation by making at least one of the utterance, the movement, the expression.

Further, at 210, the method 200 may include obtaining, using the processing device, at least one output corresponding to the at least one agent avatar based on the at least one input.

Further, at 212, the method 200 may include generating, using the processing device, at least one exploring parameter for exploring the at least one interactive representation by the at least one user avatar with the at least one agent avatar based on the at least one input and the at least one output.

Further, at 214, the method 200 may include transmitting, using the communication device, the at least one exploring parameter and the at least one output to the at least one user device. Further, the at least one user device may be configured for rendering the at least one user avatar, the at least one agent avatar, and the exploring of the at least one interactive representation by the at least one user avatar with the at least one agent avatar based on the at least one input, the at least one output, and the at least one exploring parameter. Further, the exploring of the at least one interactive representation may include interacting of the at least one user avatar and the at least one agent avatar based on the at least one input and the at least one output. Further, the at least one input may include at least one query and the at least one output may include at least one response. Further, the transmitting of the at least one interactive representation may include sending an interactive user interface and the at least one interactive representation to the at least one user device for presenting the at least one interactive representation in the interactive user interface using the at least one user device. Further, the interactive user interface may be a three-dimensional interactive user interface. Further, the interactive user interface may include digital and/or virtual buttons, search boxes, sliders, etc. Further, in an embodiment, the generating of the at least one input may be based on interacting with the digital and/or virtual buttons, the sliders, etc., by the at least one user using the at least one user device. Further, in an embodiment, the transmitting of the at least one interactive representation may include transmitting at least a portion of the at least one interactive representation to the at least one user device. Further, in an embodiment, the method 200 may include detecting, using the processing device, a bandwidth of a network connection associated with the at least one user device based on the at least one request. Further, the method 200 may include determining, using the processing device, a portion of the at least one interactive representation that is to be transmitted based on the bandwidth. Further, the transmitting of the at least one interactive representation may include transmitting the portion of the at least one interactive representation to the at least one user device.

Further, at 216, the method 200 may include storing, using a storage device, the at least one interactive representation (such as a storage device 606).

Further, in some embodiments, the at least one exploring parameter may include at least one navigational parameter and at least one experiencing parameter. Further, the rendering of the exploring may include navigating the at least one interactive representation by the at least one user avatar with the at least one agent avatar and experiencing the at least one interactive representation by the at least one user avatar with the at least one agent avatar. Furthermore, the at least one navigational parameter for navigating the at least one interactive representation by the at least one user avatar with the at least one agent avatar may include a direction of movement, an amount of movement, a path of movement, etc. Furthermore, the at least one experiencing parameter for experiencing the at least one interactive representation by the at least one user avatar with the at least one agent avatar may include a view angle, a view direction, a view position, a view orientation, etc. Further, the one or more view perspectives may include a first person view, a third person view, etc.

Further, in some embodiments, the at least one interactive representation may include at least one first digital representation of at least one sale location associated with the at least one real estate property. Further, the at least one sale location may include a virtual sale location for the at least one real estate property. Further, the generating of the at least one interactive representation may include generating the at least one first digital representation of the at least one sale location comprising the at least one user avatar and the at least one agent avatar.

Further, in some embodiments, the at least one interactive representation may include at least one second digital representation of the at least one real estate property. Further, the exploring of the at least one interactive representation may include moving of the at least one user avatar with the at least one agent avatar from the at least one first digital representation to the at least one second digital representation based on the at least one input and the at least one output.

Further, in some embodiments, the at least one request may include at least one display characteristic associated with a display of the at least one user device. Further, the at least one display characteristic may include display type (2D display, 3D display, a projection display, a screen display, etc.), a display size, a display resolution, etc. Further, the method 200 may include analyzing the at least one display characteristic using at least one machine learning model. Further, the generating of the at least one interactive representation may be further based on the analyzing of the at least one display characteristic. Further, the at least one interactive representation may be presentable on the at least one user device.

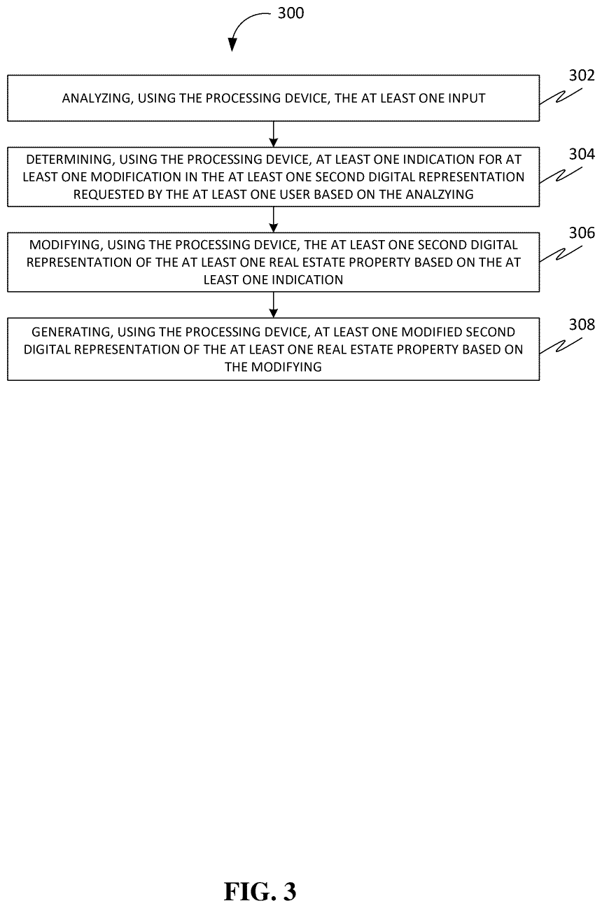

FIG. 3 is a flowchart of a method 300 for facilitating interactive and guided experiencing of virtual real estate properties, in accordance with some embodiments.

Further, at 302, the method 300 may include analyzing, using the processing device, the at least one input.

Further, at 304, the method 300 may include determining, using the processing device, at least one indication for at least one modification in the at least one second digital representation requested by the at least one user based on the analyzing. Further, the at least one second digital representation may include at least one digital component representing at least one real estate component of the at least one real estate property. Further, the at least one real estate component may include a room, a bathroom, a porch, a parking, a lawn, a backyard, etc. Further, the at least one digital component may include at least one digital object (such as a furniture, a pool, a bathtub, an interior, etc.) present in the at least one digital component representing the at least one real estate component. Further, the at least one modification may include a modification of a design of the at least one real estate component, a location of the at least one real estate component, an appearance of the at least one real estate component, an addition of the at least one digital object, a replacement of the at least one digital object, a removal of the at least one digital object, etc.

Further, at 306, the method 300 may include modifying, using the processing device, the at least one second digital representation of the at least one real estate property based on the at least one indication.

Further, at 308, the method 300 may include generating, using the processing device, at least one modified second digital representation of the at least one real estate property based on the modifying. Further, the at least one interactive representation further may include the at least one modified second digital representation. Further, the generating of the at least one modified second digital representation may be based on at least one generative artificial intelligence (AI) model. Further, the at least one generative AI model may be trained on a dataset including a plurality of variations of the design of the at least one real estate component, the location of the at least one real estate component, the appearance of the at least one real estate component, the at least one digital object, etc. Further, the at least one generative AI model may identify a particular variation of the design of the at least one real estate component, the location of the at least one real estate component, the appearance of the at least one real estate component, the at least one digital object, etc., and produce the at least one modification in the at least one second digital representation based on applying the variation to the at least one second digital representation for the generating of the at least one modified second digital representation.

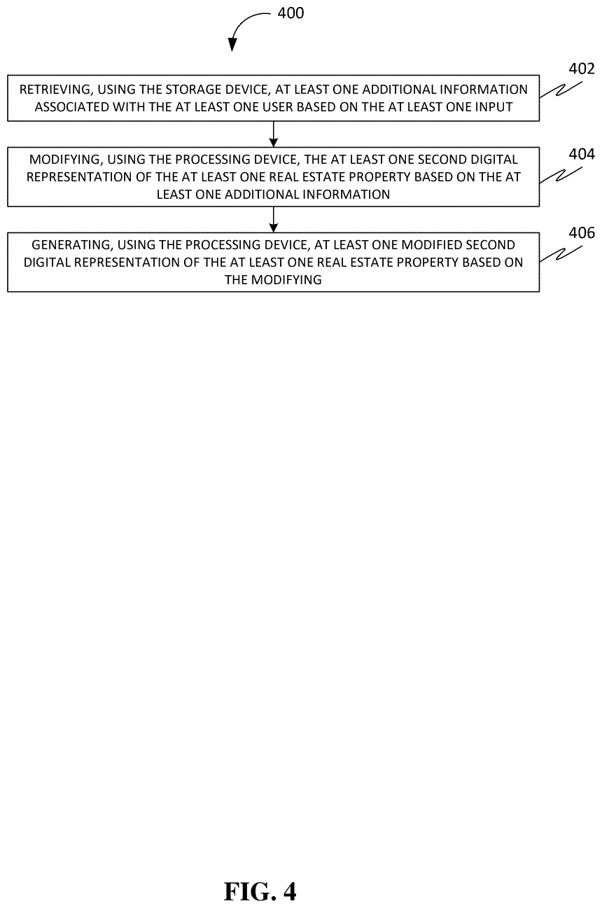

FIG. 4 is a flowchart of a method 400 for facilitating interactive and guided experiencing of virtual real estate properties, in accordance with some embodiments.

Further, at 402, the method 400 may include retrieving, using the storage device, at least one additional information associated with the at least one user based on the at least one input. Further, the at least one additional information may include at least one preference of the at least one user for the at least one real estate component and at least one digital object present in the at least one digital component representing the at least one real estate component. Further, the at least one additional information may include at least one social media data associated with the at least one user.

Further, at 404, the method 400 may include modifying, using the processing device, the at least one second digital representation of the at least one real estate property based on the at least one additional information.

Further, at 406, the method 400 may include generating, using the processing device, at least one modified second digital representation of the at least one real estate property based on the modifying. Further, the at least one interactive representation may include the at least one modified second digital representation.

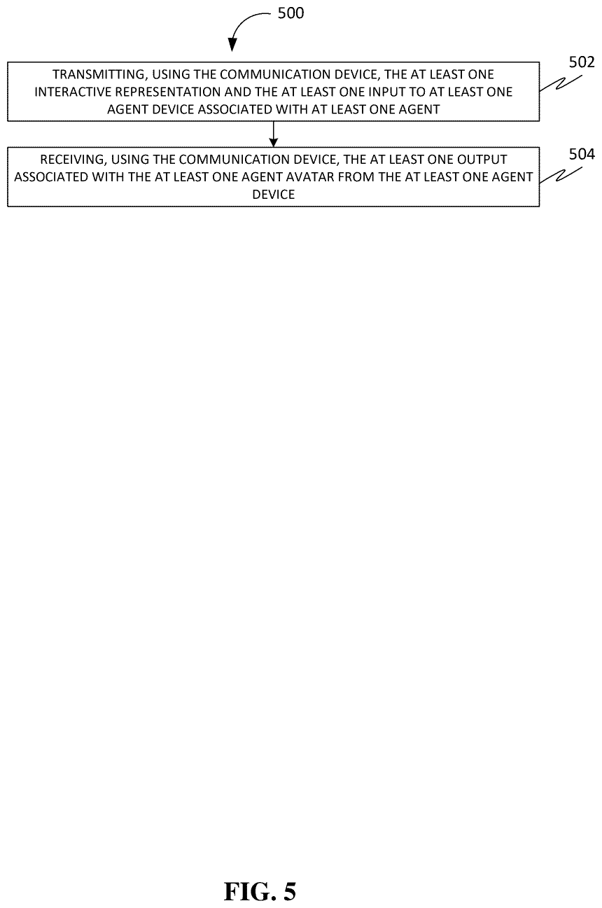

FIG. 5 is a flowchart of a method 500 for facilitating interactive and guided experiencing of virtual real estate properties, in accordance with some embodiments.

Further, at 502, the method 500 may include transmitting, using the communication device, the at least one interactive representation and the at least one input to at least one agent device (such as at least one agent device 802) associated with at least one agent. Further, the at least one agent device may be configured for presenting the at least one interactive representation and rendering the at least one user avatar based on the at least one input. Further, the at least one agent device may include, but may not be limited to, a computing device, a smartphone, a virtual reality headset, a mixed reality headset, a laptop, a desktop, a tablet, etc.

Further, at 504, the method 500 may include receiving, using the communication device, the at least one output associated with the at least one agent avatar from the at least one agent device. Further, the obtaining may be further based on the receiving of the at least one output.

Further, in some embodiments, the at least one agent device may include at least one sensor (such as at least one sensor 902). Further, the at least one sensor may be configured for generating the at least one output based on capturing at least one of a movement, an utterance, and an expression of the at least one agent. Further, the at least one sensor may include an imaging sensor (camera), a microphone, a motion sensor, an eye tracking sensor, etc.

Further, in some embodiments, the obtaining may include analyzing the at least one input using at least one of a machine learning model and a natural language processing model. Further, at least one of the machine learning model and the natural language processing model may be trained on a dataset using at least one algorithm for detecting at least one of a movement, an utterance, and an expression of the at least one user. Further, the obtaining may include generating the at least one output associated with the at least one agent avatar based on the analyzing.

Further, in some embodiments, the at least one user device may include at least one sensor (such as at least one sensor 1002). Further, the at least one sensor may be configured for generating the at least one input based on capturing at least one of a movement, an utterance, an expression of the at least one user. Further, the at least one sensor may include an imaging sensor (camera), a microphone, a motion sensor, an eye tracking sensor, etc.

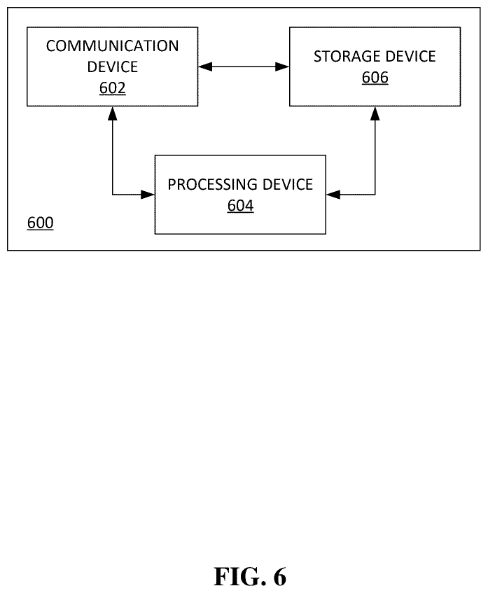

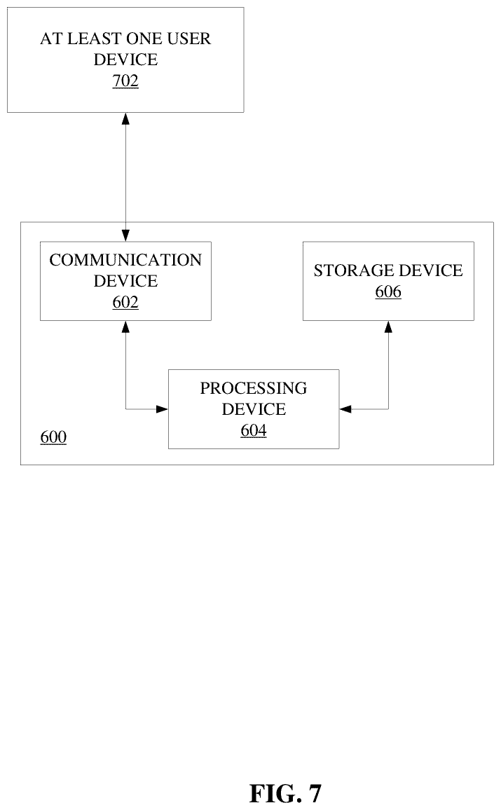

FIG. 6 is a block diagram of a system 600 for facilitating interactive and guided experiencing of virtual real estate properties, in accordance with some embodiments. Accordingly, the system 600 may include a communication device 602, a processing device 604, and a storage device 606. Further, the communication device 602 may be configured for receiving at least one request from at least one user device 702, as shown in FIG. 7, associated with at least one user. Further, the at least one user device 702 may include, but may not be limited to, a smartphone, a virtual reality headset, a laptop, a desktop, a tablet computer, etc. Further, the communication device 602 may be configured for transmitting at least one interactive representation to the at least one user device 702. Further, the at least one user device 702 may be configured for presenting the at least one interactive representation to the at least one user. Further, the communication device 602 may be configured for receiving at least one input associated with the at least one user from the at least one user device 702. Further, the communication device 602 may be configured for transmitting at least one exploring parameter and at least one output to the at least one user device 702.

Further, the processing device 604 may be communicatively coupled with the communication device 602. Further, the processing device 604 may be configured for generating the at least one interactive representation associated with at least one real estate property based on the at least one request. Further, the at least one interactive representation may include at least one agent avatar and at least one user avatar associated with the at least one user. Further, the processing device 604 may be configured for obtaining the at least one output corresponding to the at least one agent avatar based on the at least one input. Further, the processing device 604 may be configured for generating the at least one exploring parameter for exploring the at least one interactive representation by the at least one user avatar with the at least one agent avatar based on the at least one input and the at least one output. Further, the at least one user device 702 may be configured for rendering the at least one user avatar, the at least one agent avatar, and the exploring of the at least one interactive representation by the at least one user avatar with the at least one agent avatar based on the at least one input, the at least one output, and the at least one exploring parameter. Further, the storage device 606 may be communicatively coupled with the processing device 604.

Further, the storage device 606 may be configured for storing the at least one interactive representation.

Further, in some embodiments, the at least one exploring parameter may include at least one navigational parameter and at least one experiencing parameter. Further, the rendering of the exploring may include navigating the at least one interactive representation by the at least one user avatar with the at least one agent avatar and experiencing the at least one interactive representation by the at least one user avatar with the at least one agent avatar.

Further, in some embodiments, the at least one interactive representation may include at least one first digital representation of at least one sale location associated with the at least one real estate property. Further, the generating of the at least one interactive representation may include generating the at least one first digital representation of the at least one sale location comprising the at least one user avatar and the at least one agent avatar.

Further, in some embodiments, the at least one interactive representation may include at least one second digital representation of the at least one real estate property. Further, the exploring of the at least one interactive representation may include moving of the at least one user avatar with the at least one agent avatar from the at least one first digital representation to the at least one second digital representation based on the at least one input and the at least one output.

Further, in some embodiments, the processing device 604 may be configured for analyzing the at least one input. Further, the processing device 604 may be configured for determining at least one indication for at least one modification in the at least one second digital representation requested by the at least one user based on the analyzing. Further, the processing device 604 may be configured for modifying the at least one second digital representation of the at least one real estate property based on the at least one indication. Further, the processing device 604 may be configured for generating at least one modified second digital representation of the at least one real estate property based on the modifying. Further, the at least one interactive representation may include the at least one modified second digital representation.

Further, in some embodiments, the storage device 606 may be configured for retrieving at least one additional information associated with the at least one user based on the at least one input. Further, the processing device 604 may be configured for modifying the at least one second digital representation of the at least one real estate property based on the at least one additional information. Further, the processing device 604 may be configured for generating at least one modified second digital representation of the at least one real estate property based on the modifying. Further, the at least one interactive representation may include the at least one modified second digital representation.

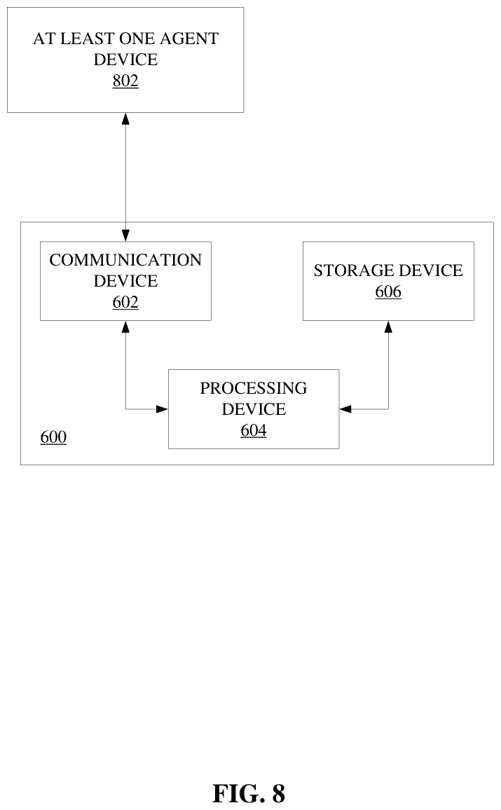

Further, in some embodiments, the communication device 602 may be configured for transmitting the at least one interactive representation and the at least one input to at least one agent device 802, as shown in FIG. 8, associated with at least one agent. Further, the at least one agent device 802 may be configured for presenting the at least one interactive representation and rendering the at least one user avatar based on the at least one input. Further, the at least one agent device 802 may include, but may not be limited to, a smartphone, a virtual reality headset, a laptop, a desktop, a tablet computer, etc. Further, the communication device 602 may be configured for receiving the at least one output associated with the at least one agent avatar from the at least one agent device 802. Further, the obtaining may be based on the receiving of the at least one output.

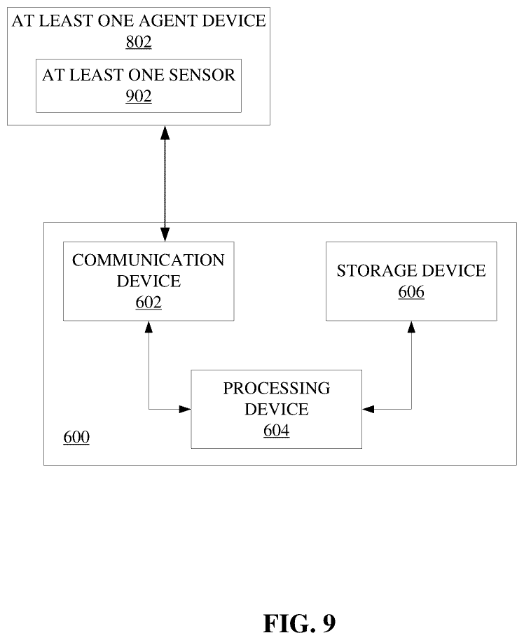

Further, in some embodiments, the at least one agent device 802 may include at least one sensor 902, as shown in FIG. 9. Further, the at least one sensor 902 may be configured for generating the at least one output based on capturing at least one of a movement, an utterance, and an expression of the at least one agent.

Further, in some embodiments, the obtaining may include analyzing the at least one input using at least one of a machine learning model and a natural language processing model. Further, at least one of the machine learning model and the natural language processing model may be trained on a dataset using at least one algorithm for detecting at least one of a movement, an utterance, and an expression of the at least one user. Further, the obtaining may include generating the at least one output associated with the at least one agent avatar based on the analyzing.

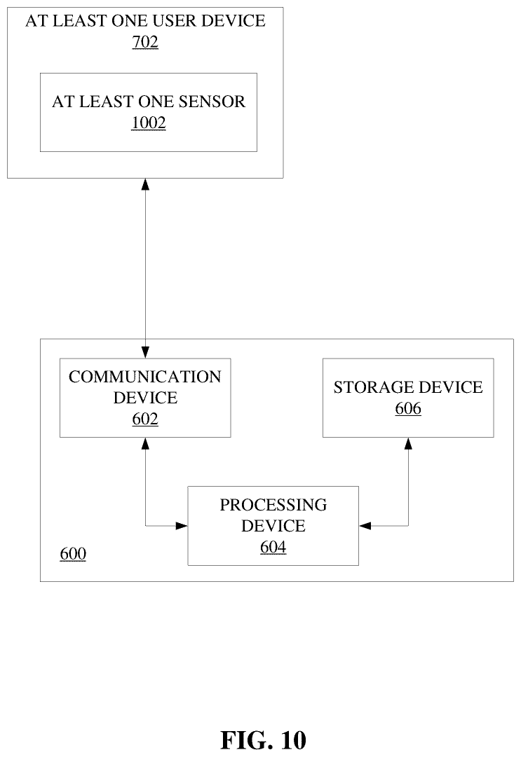

Further, in some embodiments, the at least one user device 702 may include at least one sensor 1002, as shown in FIG. 10. Further, the at least one sensor 1002 may be configured for generating the at least one input based on capturing at least one of a movement, an utterance, an expression of the at least one user. FIG. 7 is a block diagram of the system 600 for facilitating interactive and guided experiencing of virtual real estate properties, in accordance with some embodiments.

FIG. 8 is a block diagram of the system 600 for facilitating interactive and guided experiencing of virtual real estate properties, in accordance with some embodiments.

FIG. 9 is a block diagram of the system 600 for facilitating interactive and guided experiencing of virtual real estate properties, in accordance with some embodiments.

FIG. 10 is a block diagram of the system 600 for facilitating interactive and guided experiencing of virtual real estate properties, in accordance with some embodiments.

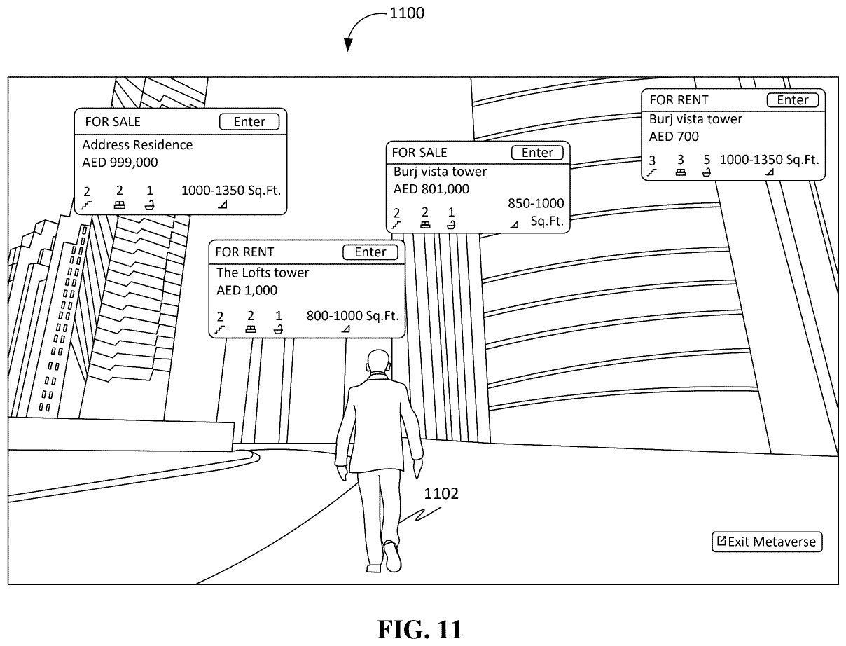

FIG. 11 is a schematic of an interactive representation 1100 of a geographical area, in accordance with some embodiments. Accordingly, the interactive representation 1100 may include at least one user avatar 1102 associated with at least one user. Further, the interactive representation may include at least one digital representation of at least one real estate property. Further, the at least one user may want to search and discover the at least one real estate property in the geographical area (city). Further, the at least one digital representation of the at least one real estate property may be interactively explorable by the at least one user by navigating the at least one digital representation.

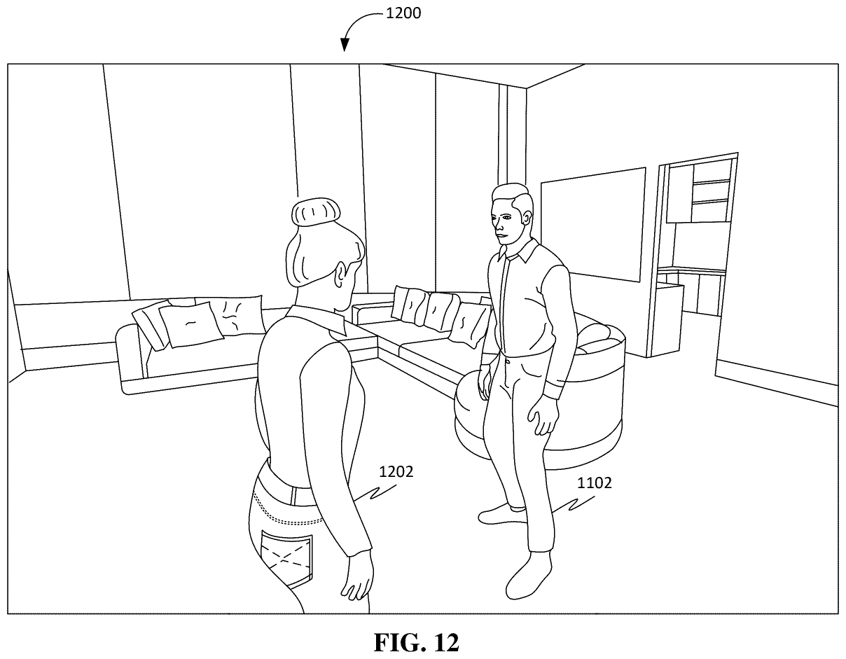

FIG. 12 is a schematic of an interactive representation 1200 of a location associated with the at least one real estate property, in accordance with some embodiments. Further, the interactive representation 1200 may include the at least one user avatar 1102 and at least one agent avatar 1202

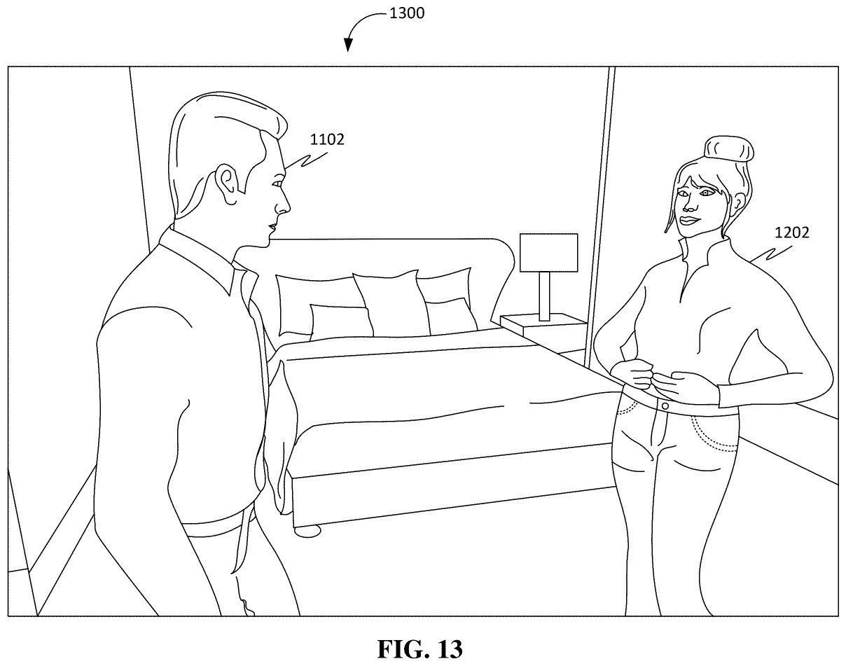

FIG. 13 is a schematic of an interactive representation 1300 of a location associated with the at least one real estate property, in, in accordance with some embodiments. Further, the interactive representation 1300 may include the at least one user avatar 1102 and at least one agent avatar 1202

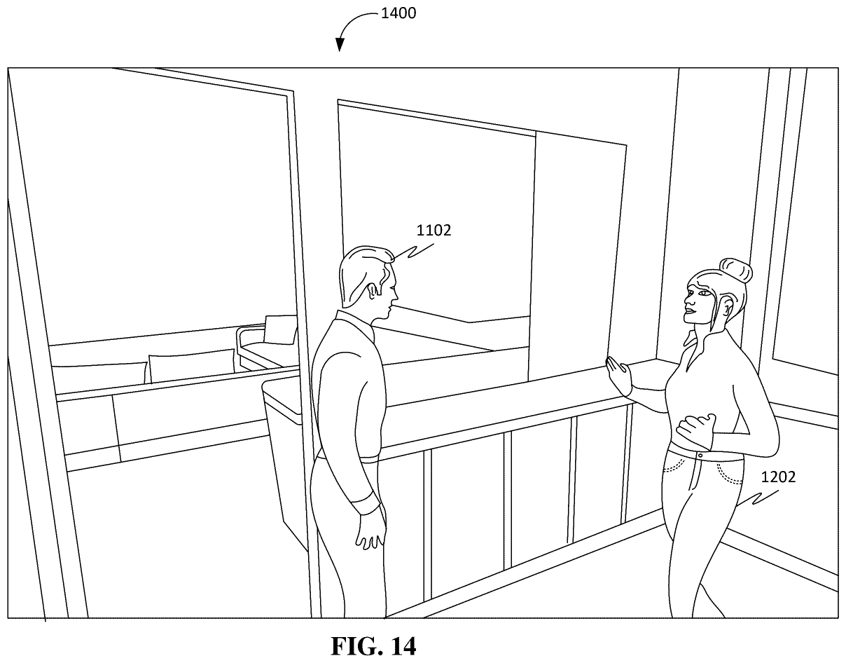

FIG. 14 is a schematic of an interactive representation 1400 of a location associated with the at least one real estate property, in, in accordance with some embodiments. Further, the interactive representation 1400 may include the at least one user avatar 1102 and at least one agent avatar 1202

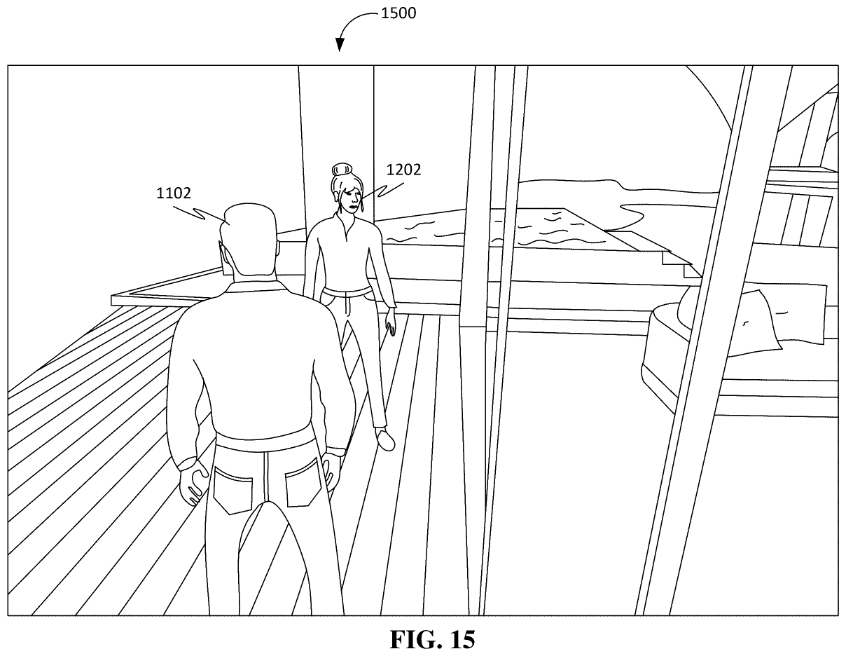

FIG. 15 is a schematic of an interactive representation 1500 of a location associated with the at least one real estate property, in, in accordance with some embodiments. Further, the interactive representation 1500 may include the at least one user avatar 1102 and at least one agent avatar 1202

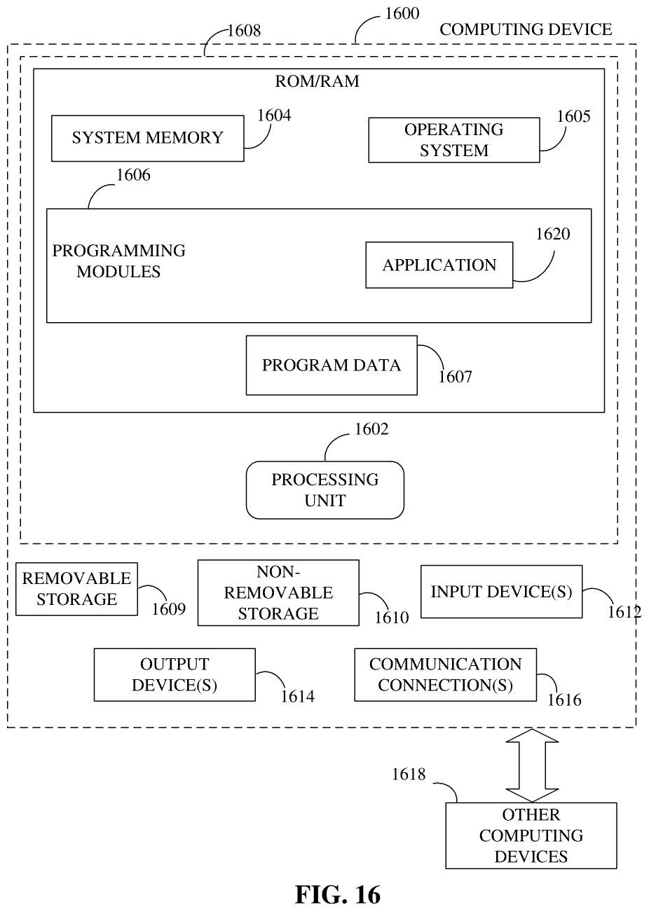

With reference to FIG. 16, a system consistent with an embodiment of the disclosure may include a computing device or cloud service, such as computing device 1600. In a basic configuration, computing device 1600 may include at least one processing unit 1602 and a system memory 1604. Depending on the configuration and type of computing device, system memory 1604 may comprise, but is not limited to, volatile (e.g. random-access memory (RAM)), non-volatile (e.g. read-only memory (ROM)), flash memory, or any combination. System memory 1604 may include operating system 1605, one or more programming modules 1606, and may include a program data 1607. Operating system 1605, for example, may be suitable for controlling computing device 1600′s operation. In one embodiment, programming modules 1606 may include image-processing module, machine learning module. Furthermore, embodiments of the disclosure may be practiced in conjunction with a graphics library, other operating systems, or any other application program and is not limited to any particular application or system. This basic configuration is illustrated in FIG. 16 by those components within a dashed line 1608.

Computing device 1600 may have additional features or functionality. For example, computing device 1600 may also include additional data storage devices (removable and/or non-removable) such as, for example, magnetic disks, optical disks, or tape. Such additional storage is illustrated in FIG. 16 by a removable storage 1609 and a non-removable storage 1610. Computer storage media may include volatile and non-volatile, removable and non-removable media implemented in any method or technology for storage of information, such as computer-readable instructions, data structures, program modules, or other data. System memory 1604, removable storage 1609, and non-removable storage 1610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1600. Any such computer storage media may be part of device 1600. Computing device 1600 may also have input device(s) 1612 such as a keyboard, a mouse, a pen, a sound input device, a touch input device, a location sensor, a camera, a biometric sensor, etc. Output device(s) 1614 such as a display, speakers, a printer, etc. may also be included. The aforementioned devices are examples and others may be used.

Computing device 1600 may also contain a communication connection 1616 that may allow device 1600 to communicate with other computing devices 1618, such as over a network in a distributed computing environment, for example, an intranet or the Internet. Communication connection 1616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The term computer readable media as used herein may include both storage media and communication media.

As stated above, a number of program modules and data files may be stored in system memory 1604, including operating system 1605. While executing on processing unit 1602, programming modules 1606 (e.g., application 1620 such as a media player) may perform processes including, for example, one or more stages of methods, algorithms, systems, applications, servers, databases as described above. The aforementioned process is an example, and processing unit 1602 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method for facilitating interactive and guided experiencing of virtual real estate properties, the method comprising:
receiving, using a communication device, at least one request from at least one user device associated with at least one user;
generating, using a processing device, at least one interactive representation associated with at least one real estate property based on the at least one request, wherein the at least one interactive representation comprises at least one agent avatar and at least one user avatar associated with the at least one user;
transmitting, using the communication device, the at least one interactive representation to the at least one user device, wherein the at least one user device is configured for presenting the at least one interactive representation to the at least one user;
receiving, using the communication device, at least one input associated with the at least one user from the at least one user device;
obtaining, using the processing device, at least one output corresponding to the at least one agent avatar based on the at least one input;
generating, using the processing device, at least one exploring parameter for exploring the at least one interactive representation by the at least one user avatar with the at least one agent avatar based on the at least one input and the at least one output;
transmitting, using the communication device, the at least one exploring parameter and the at least one output to the at least one user device, wherein the at least one user device is configured for rendering the at least one user avatar, the at least one agent avatar, and the exploring of the at least one interactive representation by the at least one user avatar with the at least one agent avatar based on the at least one input, the at least one output, and the at least one exploring parameter; and
storing, using a storage device, the at least one interactive representation.

2. The method of claim 1, wherein the at least one exploring parameter comprises at least one navigational parameter and at least one experiencing parameter, wherein the rendering of the exploring comprises navigating the at least one interactive representation by the at least one user avatar with the at least one agent avatar and experiencing the at least one interactive representation by the at least one user avatar with the at least one agent avatar.

3. The method of claim 1, wherein the at least one interactive representation comprises at least one first digital representation of at least one sale location associated with the at least one real estate property, wherein the generating of the at least one interactive representation comprises generating the at least one first digital representation of the at least one sale location comprising the at least one user avatar and the at least one agent avatar.

4. The method of claim 3, wherein the at least one interactive representation further comprises at least one second digital representation of the at least one real estate property, wherein the exploring of the at least one interactive representation comprises moving of the at least one user avatar with the at least one agent avatar from the at least one first digital representation to the at least one second digital representation based on the at least one input and the at least one output.

5. The method of claim 4 further comprising:
analyzing, using the processing device, the at least one input;
determining, using the processing device, at least one indication for at least one modification in the at least one second digital representation requested by the at least one user based on the analzying;
modifying, using the processing device, the at least one second digital representation of the at least one real estate property based on the at least one indication; and
generating, using the processing device, at least one modified second digital representation of the at least one real estate property based on the modifying, wherein the at least one interactive representation further comprises the at least one modified second digital representation.

6. The method of claim 4 further comprising:
retrieving, using the storage device, at least one additional information associated with the at least one user based on the at least one input;
modifying, using the processing device, the at least one second digital representation of the at least one real estate property based on the at least one additional information; and
generating, using the processing device, at least one modified second digital representation of the at least one real estate property based on the modifying, wherein the at least one interactive representation further comprises the at least one modified second digital representation.

7. The method of claim 1 further comprising:
transmitting, using the communication device, the at least one interactive representation and the at least one input to at least one agent device associated with at least one agent, wherein the at least one agent device is configured for presenting the at least one interactive representation and rendering the at least one user avatar based on the at least one input; and
receiving, using the communication device, the at least one output associated with the at least one agent avatar from the at least one agent device, wherein the obtaining is further based on the receiving of the at least one output.

8. The method of claim 7, wherein the at least one agent device comprises at least one sensor, wherein the at least one sensor is configured for generating the at least one output based on capturing at least one of a movement, an utterance, and an expression of the at least one agent.

9. The method of claim 1, wherein the obtaining further comprises:
analyzing the at least one input using at least one of a machine learning model and a natural language processing model, wherein at least one of the machine learning model and the natural language processing model is trained on a dataset using at least one algorithm for detecting at least one of a movement, an utterance, and an expression of the at least one user; and
generating the at least one output associated with the at least one agent avatar based on the analyzing.

10. The method of claim 1, wherein the at least one user device comprises at least one sensor, wherein the at least one sensor is configured for generating the at least one input based on capturing at least one of a movement, an utterance, an expression of the at least one user.

11. A system for facilitating interactive and guided experiencing of virtual real estate properties, the system comprising:
a communication device configured for:
receiving at least one request from at least one user device associated with at least one user;
transmitting at least one interactive representation to the at least one user device, wherein the at least one user device is configured for presenting the at least one interactive representation to the at least one user;
receiving at least one input associated with the at least one user from the at least one user device; and
transmitting at least one exploring parameter and at least one output to the at least one user device;
a processing device communicatively coupled with the communication device, wherein the processing device is configured for:
generating the at least one interactive representation associated with at least one real estate property based on the at least one request, wherein the at least one interactive representation comprises at least one agent avatar and at least one user avatar associated with the at least one user;
obtaining the at least one output corresponding to the at least one agent avatar based on the at least one input; and
generating the at least one exploring parameter for exploring the at least one interactive representation by the at least one user avatar with the at least one agent avatar based on the at least one input and the at least one output, wherein the at least one user device is configured for rendering the at least one user avatar, the at least one agent avatar, and the exploring of the at least one interactive representation by the at least one user avatar with the at least one agent avatar based on the at least one input, the at least one output, and the at least one exploring parameter; and
a storage device communicatively coupled with the processing device, wherein the storage device is configured for storing the at least one interactive representation.

12. The system of claim 11, wherein the at least one exploring parameter comprises at least one navigational parameter and at least one experiencing parameter, wherein the rendering of the exploring comprises navigating the at least one interactive representation by the at least one user avatar with the at least one agent avatar and experiencing the at least one interactive representation by the at least one user avatar with the at least one agent avatar.

13. The system of claim 11, wherein the at least one interactive representation comprises at least one first digital representation of at least one sale location associated with the at least one real estate property, wherein the generating of the at least one interactive representation comprises generating the at least one first digital representation of the at least one sale location comprising the at least one user avatar and the at least one agent avatar.

14. The system of claim 13, wherein the at least one interactive representation further comprises at least one second digital representation of the at least one real estate property, wherein the exploring of the at least one interactive representation comprises moving of the at least one user avatar with the at least one agent avatar from the at least one first digital representation to the at least one second digital representation based on the at least one input and the at least one output.

15. The system of claim 14, wherein the processing device is further configured for:
analyzing the at least one input;
determining at least one indication for at least one modification in the at least one second digital representation requested by the at least one user based on the analzying;
modifying the at least one second digital representation of the at least one real estate property based on the at least one indication; and
generating at least one modified second digital representation of the at least one real estate property based on the modifying, wherein the at least one interactive representation further comprises the at least one modified second digital representation.

16. The system of claim 14, wherein the storage device is configured for retrieving at least one additional information associated with the at least one user based on the at least one input, wherein the processing device is further configured for:
modifying the at least one second digital representation of the at least one real estate property based on the at least one additional information; and
generating at least one modified second digital representation of the at least one real estate property based on the modifying, wherein the at least one interactive representation further comprises the at least one modified second digital representation.

17. The system of claim 11, wherein the communication device is further configured for:
transmitting the at least one interactive representation and the at least one input to at least one agent device associated with at least one agent, wherein the at least one agent device is configured for presenting the at least one interactive representation and rendering the at least one user avatar based on the at least one input; and
receiving the at least one output associated with the at least one agent avatar from the at least one agent device, wherein the obtaining is further based on the receiving of the at least one output.

18. The system of claim 17, wherein the at least one agent device comprises at least one sensor, wherein the at least one sensor is configured for generating the at least one output based on capturing at least one of a movement, an utterance, and an expression of the at least one agent.

19. The system of claim 11, wherein the obtaining further comprises:
analyzing the at least one input using at least one of a machine learning model and a natural language processing model, wherein at least one of the machine learning model and the natural language processing model is trained on a dataset using at least one algorithm for detecting at least one of a movement, an utterance, and an expression of the at least one user; and
generating the at least one output associated with the at least one agent avatar based on the analyzing.

20. The system of claim 11, wherein the at least one user device comprises at least one sensor, wherein the at least one sensor is configured for generating the at least one input based on capturing at least one of a movement, an utterance, an expression of the at least one user.
